(19) United States
(12) Patent Application Publication
(10) Pub. No.: US 2019/0150443 A1
(43) Pub. Date: May 23, 2019

(54) COMPOSITIONS AND METHODS FOR CONTROLLING FECUNDITY OF ARACHNIDA SPECIES

(71) Applicant: FMC Corporation, Philadelphia, PA (US)

(72) Inventor: Nathan D. Caldwell, Morrisville, PA (US)

(21) Appl. No.: 16/091,637

(22) PCT Filed: Apr. 5, 2017
(86) PCT No.: PCT/US17/26063

§ 371 Date: Oct. 5, 2018

Related U.S. Application Data
(60) Provisional application No. 62/319,021, filed on Apr. 6, 2016.

(51) Int. Cl. A01N 43/713; A01N 53/00

(52) U.S. Cl. CPC A01N 43/713; A01N 37/38; A01N 53/00

(57) ABSTRACT

Compositions comprising tetraniliprole and at least one additional plant protection agent are provided. Methods of using the composition for controlling fecundity of an Arachnida species are also disclosed.

### FIELD OF THE INVENTION

The present invention relates to the field of agrochemical compositions and formulations. In particular, the invention provides a composition comprising a tetraniliprole, alone or in combination with a plant protection agent, suitable for controlling fecundity of Arachnida species.

### BACKGROUND OF THE INVENTION

Various Arachnida species such as spider mites, and particularly Tetranychus urticae (two-spotted spider mite, aka TSSM or TSM) are known as a major pest in agriculture. T. urticae is extremely polyphagous and feed on over 1000 plant species. T. urticae represent a key pest for greenhouse crops, annual field crops and many horticultural crops, such as peppers, tomatoes, potatoes, beans, corn, strawberries and roses. It is widespread all over the world, and occurs freely in nature in regions with a warm and dry climate. Spider mites cause yellow flecks on the leaf surface, and upon heavy infestation, leaves become pale, brittle and covered in webbing. This damage can cause severe reduction in yield. Spider mites are particularly important pests for vegetables. Spider mites cause significant damage to greenhouse tomato, cucumber and pepper crops. Moreover, it shows a rapid development (generation time of 5-7 days in a hot season).

Given the short generation time and high reproduction rate of spider mites, it is expected that spider mites, with the climate change will become one of the major pests for crops as well. Devastating effects of spider mites are already creating enormous problems for the agricultural production in part of Europe.

Therefore, a need exists to develop an effective method of controlling fecundity of Arachnida species, in particular TSSM.

### SUMMARY OF THE INVENTION

An aspect of the invention provides a composition for controlling fecundity of an Arachnida species. The composition contains an effective amount of tetraniliprole and at least one plant protection agent; wherein the plant protection agent is selected from the group consisting of pesticide, arthropodicide, insecticide, acaricide, nematocide, fungicide, herbicide, plant growth regulator and a combination thereof.

In some embodiments, the plant protection agent is a pyrethroid selected from bifenthrin, cypermethrin, beta-cypermethrin, zeta-cypermethrin, deltamethrin, cis-permethrin, gamma-cyhalothrin, tralomethrin, cyfluthrin, beta-cyfluthrin, esfenvalerate and fluvalinate.

Another aspect of the invention provides a method of controlling fecundity of an Arachnida species, including applying to a plant or soil: an effective amount of tetraniliprole and at least one plant protection agent, wherein said plant protection agent is selected from the group consisting of pesticide, arthropodicide, insecticide, acaricide, nematocide, fungicide, herbicide, plant growth regulator and a combination thereof.

In some embodiments, the Arachnida species is a mite. In some embodiments, the Arachnida species is a two-spotted spider mite (TSSM). In some embodiments, the method inhibits at least one of the Arachnida life stage such as egg, larva, nymph, and adult.

Another aspect of the invention provides a method of controlling fecundity of an Arachnida species, including applying tetraniliprole to a plant. In some embodiments, the Arachnida species is a TSSM. In some embodiments, the method inhibits at least one of the Arachnida life stage such as egg, larva, nymph, and adult.

### BRIEF DESCRIPTION OF THE DRAWINGS

FIG. 1 illustrates the effect of the untreated check (UTC), tetraniliprole and Coragent® (chlorantraniliprole) on TSSM egg production during a period of about 120 hours.

FIG. 2 illustrates the effect of UTC, Tetraniliprole and Coragen on TSSM egg production during a period of about 96 hours.

### DETAILED DESCRIPTION OF THE INVENTION

Various embodiments of the present invention provide an agricultural composition for controlling fecundity of an Arachnida species. In particular, it has been found that compositions containing tetraniliprole exhibits potent activities in suppressing mite populations by decreasing egg deposition rates. This is an observation entirely unexpected in view of the activity spectrum of other diamide compounds which display neutral, weak effect or even a flaring response to mite deposition. Moreover, the combination of tetraniliprole with one or more plant protection agents further broadens spectrum insecticidal efficacy as well as suppress the growth of Arachnida species.

As used in this specification and unless otherwise indicated, the term “Arachnida” refers the class of joint-legged invertebrate animals or arthropods in the subphylum Chelicerata. Non-limiting exemplary subclasses include Acari, Amblypygi, Araneae, Haptopoda, Opiliones, Palpigradi, Phalangiotarbida, Pseudoscorpions, Ricinulei, Schizomida, Scorpions, Solifugae, Trigonotarbida, and Thelyphonida.

As used in this specification and unless otherwise indicated the term “plant protection agent” refers to a molecule or combination of molecules which express biological activity as a pesticide, arthropodicide, insecticide, acaricide, nematocide, fungicide, herbicide, plant growth regulator or a combination of two or more of these biological activities.

As used in this specification and unless otherwise indicated, the term “controlling fecundity” refers to reducing, inhibiting, or eliminating the presence of an Arachnida species during one or more of its growth stages. For example, the compositions of the present invention may be used for controlling the growth of mites at any stage such as egg, larva, nymph, and adult form.

As used in this specification and unless otherwise indicated, the term “insecticide” refers to a molecule or combination of molecules that repels, retards, or kills insects, and can be used for plant protection, edifice protection, turf protection, or protection of a person.

The term “liquid fertilizer” refers to a fertilizer in a fluid or liquid form containing various ratios of nitrogen, phosphorous and potassium (for example, but not limited to, 10% nitrogen, 34% phosphorous and 0% potassium) and micronutrients, commonly known as starter fertilizers that are high in phosphorus and promote rapid and vigorous root growth. Liquid fertilizers are commonly aqueous-based. As used herein, the term “aqueous-based” indicates that the predominant solvent or vehicle is water. The term “ambient temperature” as utilized herein shall mean any suitable temperature found in a laboratory or other working environment, and is generally not below about 15° C. nor above about 30° C.

The modifier “about” is used herein to indicate that certain preferred operating ranges, such as ranges for molar ratios for reactants, material amounts, and temperature, are not fixedly determined. The meaning will often be apparent to one of ordinary skill. For example, a recitation of a concentration of about 200 grams per liter in reference to, for example, a formulation would be interpreted to include other like concentrations that can be expected to provide similar effect for the concentration, such as 180 grams per liter or 220 grams per liter. Where guidance from the experience of those of ordinary skill is lacking, guidance from the context is lacking, and where a more specific rule is not recited below, the “about” range shall be not more than 10% of the absolute value of an end point or 10% of the range recited, whichever is less.

In at least one aspect of the invention, the compositions for controlling fecundity of an Arachnida species are described wherein the composition contains an effective amount of diamide insecticide and at least one plant protection agent; wherein the plant protection agent is selected from the group consisting of pesticide, arthropodicide, insecticide, acaricide, nematocide, fungicide, herbicide, plant growth regulator and a combination thereof.

In some embodiments, the diamide insecticide includes but is not limited to tetraniliprole, chlorantraniliprole, flubendiamide, and cyantraniliprole. In one embodiment, the composition consists essentially of tetraniliprole as the diamide insecticide. In another embodiment, the composition sole diamide insecticide used in the composition is tetraniliprole.

In some embodiments, the composition further comprises at least one plant protection agent. Suitable plant protecting agents include the following:

Insecticides:

A1) the class of carbamates consisting of aldicarb, alanycarb, benfuracarb, carbaryl, carbofuran, carbosulfan, methiocarb, methomyl, oxamyl, pirimicarb, propoxur and thiodicarb; A2) the class of organophosphates consisting of acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; A3) the class of cyclodiene organochlorine compounds such as endosulfan; A4) the class of fiproles consisting of ethiprole, fipronil, pyrafluprole and pyriprole; A5) the class of neonicotinoids consisting of acetamiprid, chlothianidin, dinotefuran, imidacloprid, nitenpyrathiacloprid and thiamethoxam; A6) the class of spinosyns such as spinosad and spinetoram; A7) glutatamate-gated chloride channel alolosteric modulators from the class of mectins consisting of abamectin, emamectin benzoate, ivermectin, lepimectin and milbemectin; A8) juvenile hormone mimics such as hydroprene, kinoprene, methoprene, fenoxycarb and pyriproxyfen; A9) selective homopteran feeding blockers such as pymetrozine, flonicamid and pyrifluquinazon; A10) mite growth inhibitors such as clofentezine, hexythiazox and etoxazole; A11) inhibitors of mitochondrial ATP synthase such as diafenthiuron, fenbutatin oxide and propargite; uncouplers of oxidative phosphorylation such as chlorfenapyr; A12) nicotinic acetylcholine receptor channel blockers such as bensultap, cartap hydrochloride, thiocyclam and thiosultap sodium; A13) inhibitors of the chitin biosynthesis type 0 from the benzoylurea class consisting of bistrifluron, diflubenzuron, flufenoxuron, hexaflumuron, lufenuron, novaluron and teflubenzuron; A14) inhibitors of the chitin biosynthesis type 1 such as buprofezin; A15) moulting disruptors such as cyromazine; A16) ecdyson receptor agonists such as methoxyfenozide, tebufenozide, halofenozide and chromafenozide; A17) octopamin receptor agonists such as amitraz; A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim; A19) voltage-dependent sodium channel blockers such as indoxacarb and metaflumizone; A20) inhibitors of the lipid synthesis such as spirodiclofen, spiromesifen and spirotetramat; A21) ryanodine receptor-modulators from the class of diamides consisting of flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl) phthalamid and (S)-3-Chlor-N1-{2-methyl-441,2,2,2-tetrafluor-1-(trifluormethyl)ethyl]phenyl}-N2-(1-methyl-2-methylsulfonylethyl) phthalamid, chloranthraniliprole and cy-anthraniliprole; A22) compounds of unknown or uncertain mode of action such as azadirachtin, amidoflumet, bifenazate, fluensulfone, piperonyl butoxide, pyridalyl, sulfoxaflor; or A23) sodium channel modulators from the class of pyrethroids consisting of acrinathrin, allethrin, bifenthrin, cyfluthrin, lambda-cyhalothrin, cyper-methrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

Fungicides:

B1) azoles selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thia-bendazole, fuberidazole, ethaboxam, etridiazole and hymexazole, azaconazole, diniconazole-M, oxpoconazol, paclobutrazol, uniconazol, 1-(4-chloro-phenyl)-2-([1,2,4]triazol-1-yl)-cycloheptanol and imazalilsulfphate; B2) strobilurins selected from the group consisting of azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate and methyl 2-(ortho-(2,5-dimethylphenyloxymethylene)-phenyl)-3-methoxyacrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclopropanecarboximidoylsulfanylmethyl)-phenyl)-acrylic acid methyl ester; B3) carboxamides selected from the group consisting of carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, 3,4-dichloro-N-(2-cyanophenyl)isothiazole-5-carboxamide, dimethomorph, flumorph, flumetover, fluopicolide (picobenzamid), zoxamide, carpropamid, diclocymet, mandipropamnid, N-(2-(443-(4-chlorophenyl)prop-2-ynyloxy]-3-methoxyphenyl)ethyl)-2-methanesulfonyl-amino-3-methylbutyramide, N-(2-(4-[3-(4-chloro-phenyl)prop-2-ynyloxyl]-3-methoxy-phenyl)ethyl)-2-ethanesulfonylamino-3-methylbutyramide, methyl 3-(4-chlorophenyl)-3-(2-isopropoxycarbonyl-amino-3-methyl-butyrylamino)propionate, N-(4′-bromobiphenyl-2-yl)-4-difluoromethylA-methylthiazole-6-carboxamide, N-(4′-trifluoromethyl-biphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3\4′-di chloro-4-fluorobiphenyl-2-yl)-3-difluoro-methyl-1-methyl-pyrazole-4-carboxamide, N-(3′,4′-dichloro-5-fluorobiphenyl-2-yl)-3-difluoromethyl-1-methylpyrazole-4-carboxamide, N-(2-cyano-phenyl)-3,4-dichloroisothiazole-5-carboxamide, 2-amino-4-methyl-thiazole-5-carboxanilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carboxamide N-(4′-chloro-3′,5-difluoro-biphenyl-2-yl)-3-trifluoromethyl-1-methyl-1H-pyrazole-4-carboxamide, N-(3′,4′-dichloro-5-fluoro-biphenyl-2-yl)-3-trifluoromethyl-1-methyl-1H-pyrazole-4-carboxamide, N-(3′,5-difluoro-4′-methyl-biphenyl-2-yl)-3-difluoromethyl-1-methyl-1H-pyrazole-4-carboxamide, N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoro-methyl-1-methyl-1H-pyrazole-4-carboxamide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxamide, 2-iodo-N-phenyl-benzamide,N-(2-bicyclo-propy 1-2-yl-phenyl)-3-difluormethyl-1-methylpyrazol-4-ylcarboxamide, N-(3′,4′,5′-trifluorobiphenyl-2-yl)-1,3-dimethylpyrazol-4-ylcarboxamide, N-(3′,4′,5′-trifluorobiphenyl-2-yl)-1,3-dimethyl-5-fluoropyrazol-4-yl-carboxamide, N-(3′,4′,5′-trnfluorobiphenyl-2-yl)-5-chloro-1,3-dimethyl-pyrazol-4-ylcarboxamiide, N-(3′,4′,5′-trifluorobiphenyl-2-yl)-3-fluoromethyl-1-methylpyrazol-4-ylcarboxamide, N-(3,4′5′-trifluorobiphenyl-2-yl)-3-(chlorofluoromethyl)-1-methylpyrazol-4-ylcarboxamide, N-(3′,4′,5′-trifluorobiphenyl-2-yl)-3-difluoromethyl-1-methylpyrazol-4-ylcarboxamide, N-(3′,4′,5′-trifluorobiphenyl-2-yl)-3-difluoromethyl-5-fluoro-1-methylpyrazol-4-ylicarboxamide, N-(3′,4′,5′-trifluorobiphenyl-2-yl)-5-chloro-3-difluoromethyl-1-methylpyrazol-4-ylcarboxamide, N-(3′, 4′, 5′-trifluorobiphenyl-2-yl)-3-(chlorodifluoromethyl)-1-methylpyrazol-4-ylcarboxamide, N-(3′,4′,5′-trifluorobiphenyl-2-yl)-1-methyl-3-trifluoromethylpyrazol-4-ylcarboxamide, N-(3′,4′,5′-trifluorobiphenyl-2-yl)-5-fluoro-1-methyl-3-trifluoromethylpyrazol-4-ylcarboxamide, N-(3′,4′,5′-trifluorobiphenyl-2-yl)-5-chloro-1-methyl-3-trifluoromethylpyrazol-4-ylcarboxamide, N-(2′,4′,5′-trifluorobiphenyl-2-yl)-1,3-dimethylpyrazol-4-ylcarboxamide, N-(2′,4′,5′-trifluorobiphenyl-2-yl)-1,3-dimethyl-5-fluoropyrazol-4-ylcarboxamide, N-(2′,4′,5′-trifluorobiphenyl-2-yl)-5-chloro-1,3-dimethylpyrazol-4-ylcarboxamide, N-(2′,4′,5′-trifluorobiphenyl-2-yl)-3-fluoromethyl-1-methylpyrazol-4-ylcarboxamide, N-(2′,4′,5′-trnfluorobiphenyl-2-yl)-3-(chlorofluoromethyl)-1-methylpyrazol-4-ylcarboxamide, N-(2′,4′,5′-trifluorobiphenyl-2-yl)-3-difluoromethyl-1-methylpyrazol-4-ylcarboxamide,N-(2′,4′,5′-trifluorobiphenyl-2-yl)-3-difluoromethyl-5-fluoro-1-methylpyrazol-4-ylcarboxamide, N-(2′,4′,5′-trifluorobiphenyl-2-yl)-5-chloro-3-difluoromethyl-1-methylpyrazol-4-ylcarboxamide, N-(2′,4′,5′-trifluorobiphenyl-2-yl)-3-(chlorodifluoromethyl)-1-methylpyrazol-4-ylcarboxamide, N-(2′,4′,5′-trifluorobiphenyl-2-yl)-1-methyl-3-trifluoromethylpyrazol-4-ylcarboxamide, N-(2′,4′,5′-trifluorobiphenyl-2-yl)-5-fluoro-1-methyl-3-trifluoromethylpyrazol-4-ylcarboxamide, N-(2′,4′,5′-trifluorobiphenyl-2-yl)-5-chloro-1-methyl-3-trifluoromethylpyrazol-4-ylcarboxamide, N-(3′,4′-dichloro-3-fluorobiphenyl-2-yl)-1-methyl-3-trifluoromethyl-1H-pyrazole-4-carboxamide, N-(3′,4′-dichloro-3-fluorobiphenyl-2-yl)-1-methyl-3-difluoromethyl-1H-pyrazole-4-carboxamide, N-(3′,4′-difluoro-3-fluorobiphenyl-2-yl)-1-methyl-3-trifluoromethyl-1H-pyrazole-4-carboxamide, N-(3′,4′-difluoro-3-fluorobiphenyl-2-yl)-1-methyl-S-difluoromethyl-1H-pyrazole-4-carboxamide, N-(3′-chloro-4′-fluoro-3-fluorobiphenyl-2-yl)-1-methyl-3-difluoromethyl-1H-pyrazole-4-carboxamide, N-(3′,4′-dichloro-4-fluorobiphenyl-2-yl)-1-methyl-3-trifluoromethyl-1H-pyrazole-4-carboxamide, N-(3′,4′-difluoro-4-fluorobiphenyl-2-yl)-1-methyl-S-trifluoromethyl-1H-pyrazole-4-carboxamide, N-(3′,4′-dichloro-4-fluorobiphenyl-2-yl)-1-methyl-3-difluoromethyl-1H-pyrazole-4-carboxamide, N-(3′,4′-difluoro-4-fluorobiphenyl-2-yl)-1-methyl-3-difluoromethyl-1H-pyrazole-4-carboxamide, N-(3′-chloro-4′-fluoro-4-fluorobiphenyl-2-yl)-1-methyl-S-difluoromethyl-1H-pyrazole-4-carboxamide, N-(3′,4′-dichloro-5-fluorobiphenyl-2-yl)-1-methyl-3-trifluoromethyl-1H-pyrazole-4-carboxamide, N-(3′,4′-difluoro-5-fluorobiphenyl-2-yl)-1-methyl-3-trifluoromethyl-1H-pyrazole-4-carboxamide, N-(3′,4′-dichloro-5-fluorobiphenyl-2-yl)-1-methyl-S-difluoromethyl-1H-pyrazole-carboxamide, N-(3′,4′-difluoro-5-fluorobiphenyl-2-yl)-1-methyl-3-difluoromethyl-1H-pyrazole-4-carboxamide, N-(3′,4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-fluorobiphenyl-2-yl)-1-methyl-3-trifluoromethyl-1H-pyrazole-4-carboxamide, N-(4′-chloro-5-fluorobiphenyl-2-yl)-1-methyl-3-trifluoromethyl-1H-pyrazole-4-carboxamide, N-(4′-methyl-5-fluorobiphenyl-2-yl)-1-methyl-3-trifluoromethyl-1H-pyrazole-4-carboxamide, N-(4′-fluoro-5-fluorobiphenyl-2-yl)-1,3-dimethyl-1H-pyrazole-4-carboxamide, N-(4′-chloro-5-fluorobiphenyl-2-yl)-1,3-dimethyl-1H-pyrazole-4-carboxamide, N-(4′-methyl-5-fluorobiphenyl-2-yl)-1,3-dimethyl-1H-pyrazole-4-carboxamide, N-(4′-fluoro-6-fluorobiphenyl-2-yl)-1-methyl-3-trifluoromethyl-1H-pyrazole-4-carboxamide, N-(4′-chloro-6-fluorobiphenyl-2-yl)-1-methyl-3-trifluoromethyl-1H-pyrazole-4-carboxamide, N-[2-(1,1,2,3,3,3-hexafluoropropoxy)-phenyl 1-3-difluoromethyl-1-methyl-1H-pyrazole-4-carboxamide, N-[4′-(trifluoromethylthio)-biphenyl-2-yl]-3-difluoromethyl-1-methyl-1H-pyrazole-4-carboxamide and N44′-(trifluoromethylthio)-biphenyl-2-yl]-1-methyl-3-trifluoromethyl-1-methyl-1H-pyrazole-4-carboxamide; B4) heterocyclic compounds selected from the group consisting of fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, proben-azole, 5-chloro-7-(4-methyl-piperidin-1-yl)-6-(2,4,6-trifluorophenyl)41,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen. N,N-dimethyl-3-(3-bromo-6-fluoro-2-methylindole-1-sulfonyl)-[1,2,4]triazole-1-sulfonamide, 5-ethyl-6-octyl41,2,4]triazolo[1,5-a]pyrimidin-2,7-diamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro pyridin-2-yl)-methyl)-2,4-dichloro-nicotinamide, diflumetorim, nitrapyrin, dodemorphacetate, fluoroimid, blasticidin-S, chinomethionat, debacarb, difenzoquat, difenzoquat-methylsulphat, oxolinic acid and piperalin; B5) carbamates selected from the group consisting of mancozeb, maneb, metam, methasulphocarb, metiram, ferbam, propineb, thiram, zineb, ziram, diethofencarb, iprovalicarb, benthiavalicarb, propamocarb, propamocarb hydrochlorid, 4-fluorophenyl N-(1-(1-(4-cyanophenyl)-ethanesulfonyl)but-2-yl)carbamate, methyl 3-(4-chloro-phenyl)-3-(2-isopropoxycarbonylamino-3-methyl-butyrylamino)propanoate; or B6) other fungicides selected from the group consisting of guanidine, dodine, dodine free base, iminoctadine, guazatine, antibiotics: kasugamycin, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts, organophosphorus compounds: edifenphos, iprobenfos, fosetyl, fosetyl-aluminum, phosphorous acid and its salts, pyrazophos, tolclofos-methyl, organochlorine compounds: dichlofluanid, flusulfamide, hexachloro-benzene, phthalide, pencycuron, quintozene, thiophanate-methyl, tolylfluanid, others: cyflufenamid, cymoxanil, dimethirimol, ethirimol, furalaxyl, metrafenone and spiroxamine, guazatine-acetate, iminoc-tadine-triacetate, iminoctadine-tris(albesilate), kasugamycin hydrochloride hydrate, dichlorophen, pentachlorophenol and its salts, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxincopper, prohexadione calcium, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methylformamidine and N′-(5-difluormethyl-2-methyl-4-(3-trimethylsilanyl-propoxy)-phenyl)-N-ethyl-N-methyl formamidine.

Herbicides:

C1) acetyl-CoA carboxylase inhibitors (ACC), for example cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofop-butyl, diclofop-methyl, fenoxaprop-ethyl, fenoxaprop-P-ethyl, fenthiapropethyl, fluazifopbuytl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or arylaminopropionic acids, such as flamprop-methyl or flamprop-isopropyl; C2 acetolactate synthase inhibitors (ALS), for example imidazolinones, such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium. KIH-6127 or pyribenzoxym; sulfonamides, such as florasulam, flumetsulam or metosulam; or sulfonylureas, such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron-methyl, imazosulfuron, metsulfuron-methyl, nicosulfuron, primisulfuron-methyl, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron, sulfosulfuron, foramsulfuron or iodosulfuron; C3) amides, for example allidochlor (CDAA), benzovlprop-ethyl, bromobutide, chiorthiamid, diphenamid, etobenzanidibenzchlomet), fluthiamide, fosamin or monalide; C4) auxin herbicides, for example pyridinecarboxylic acids, such as clopyralid or picloram; or 2,4-D or benazolin; C5) auxin transport inhibitors, for example naptalame or diflufenzopyr; C6) carotenoid biosynthesis inhibitors, for example benzofenap, clomazone (dimethazone), diflufenican, fluorochloridone, fluridone, pyrazolynate, pyrazoxyfen, isoxaflutole, isoxachlortole, mesotrione, sulcotrione (chlormesulone), ketospiradox, flurtamone, norflurazon or amitrol; C7) enolpyruvylshikimate-3-phosphate synthase inhibitors (EPSPS), for example glyphosate or sulfosate; C8) glutamine synthetase inhibitors, for example bilanafos (bialaphos) or glufosinate-ammonium; C9) lipid biosynthesis inhibitors, for example anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC, esprocarb, molinate, pebulate, prosulfocarb, thiobencarb (benthiocarb), tri-allate or vemolate; or benfuresate or perfluidone; C10) mitosis inhibitors, for example carbamates, such as asulam, carbetamid, chlorpropham, orbencarb, pronamid (propyzamid), propham or tiocarbazil; dinitroanilines, such as benefin, butralin, dinitramin, ethalfluralin, fluchloralin, oryzalin, pendimethalin, prodiamine or trifluralin; pyridines, such as dithiopyr or thiazopyr; or butamifos, chlorthal-dimethyl (DCPA) or maleic hydrazide; C11) protoporphyrinogen IX oxidase inhibitors, for example diphenyl ethers, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or pyrazoles, such as ET-751.JV 485 or nipyraclofen; C12) photosynthesis inhibitors, for example propanil, pyridate or pyridafol; benzothiadiazinones, such as bentazone; dinitrophenols, for example bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturonisouron, linuron, methabenzthiazuron, methazole, metobenzuron, metoxuron, monolinuron, neburon, siduron or tebuthiuron; phenols, such as bromoxvnil or ioxynil; chloridazon; triazines, such as ametryn, atrazine, cyanazine, desmein, dimethamethryn, hexazinone, prometon, prometryn, propazine, simazine, simetryn, terbumeton, terbutrvn, terbutylazine or trietazine; triazinones, such as metamitron or metribuzin; uracils, such as bromacil, lenacil or terbacil; or biscarbamates, such as desmedipham or phenmedipham; C13) synergists, for example oxiranes, such as tridiphane; C14) CIS cell wall synthesis inhibitors, for example isoxaben or dichlobenil; C16) various other herbicides, for example dichloropropionic acids, such as dalapon; dihydrobenzofurans, such as ethofumesate; phenylacetic acids, such as chlorfenac (fenac); or aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon; or their environmentally compatible salts

Plant Growth Regulators:

D1) Antiauxins, such as clofibric acid, 2,3,5-tri-iodobenzoic acid; D2) Auxins such as 4-CPA, 2,4-D, 2,4-DB, 2,4-DEP, dichlorprop, fenoprop, IAA, IBA, naphthaleneacetamide, a-naphthaleneacetic acids, 1-naphthol, naphthoxyacetic acids, potassium naphthenate, sodium naphthenate, 2,4,5-T; D3) cytokinins, such as 2iP, benzyladenine, 4-hydroxyphenethyl alcohol, kinetin, zeatin; D4) defoliants, such as calcium cyanamide, dimethipin, endothal, ethephon, merphos, metoxuron, pentachlorophenol, thidiazuron, tribufos; D5) ethylene inhibitors, such as aviglycine, 1-methylcyclopropene; D6) ethylene releasers, such as ACC, etacelasil, ethephon, glyoxime; D7) gametocides, such as fenridazon, maleic hydrazide; DS) gibberellins, such as gibberellins, gibberellic acid; D9) growth inhibitors, such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, tiaojiean, 2,3,5-tri-iodobenzoic acid; D10) morphactins, such as chlorfluren, chlorflurenol, dichlorflurenol, flurenol; D11) growth retardants, such as chlormequat, daminozide, flurprimidol, mefluidide, paclobutrazol, tetcyclacis, uniconazole; D12) growth stimulators, such as brassinolide, brassinolide-ethyl, DCPTA, forchlorfenuron, hymexazol, prosuler, triacontanol; D13) unclassified plant growth regulators, such as bachmedesh, benzofluor, buminafos, carvone, choline chloride, ciobutide, clofencet, cyanamide, cyclanilide, cycloheximide, cyprosulfamide, epocholeone, ethychlozate, ethylene, fuphenthiourea, furalane, heptopargil, holosulf, inabenfide, karetazan, lead arsenate, methasulfocarb, prohexadione, pydanon, sintofen, triapenthenol, trinexapac.

The presently described composition may be in the form of a foamable formulations and/or in any appropriate conventional form, for example an emulsion concentrate (EC), a suspension concentrate (SC), a suspo-emulsion (SE), a capsule suspension (CS), a water dispersible granule (WG), an emulsifiable granule (EG), a water in oil emulsion (EO), an oil in water emulsion (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a dispersible concentrate (DC), a wettable powder (WP) or any technically feasible formulation in combination with agriculturally acceptable adjuvants.

Suitable foaming agents may be nonionic surfactants, including alkanolamides

(such as cocamide diethanolamide, lauric acid monoisopropanolamide, and ethoxylated myristamide), xyethylene fatty acid esters, polyoxyethylene fatty alcohol ethers (such as alkylaryl polyglycol ethers) and fluorocarbons (such as ethoxylated polyfluorinated alcohol); anionic surfactants including alkyl-, alkylaryl- and arylsulfonates (such as sodium lauryl sarcosinate and such as sodium alkylbenzenesulfonate), alkyl-, alkylaryl- and arylsulfates, protein hydrolysates, derivatives of polycarboxylic acid (such as ammonium lauryl ether carboxylate), olefin sulfonates (such as sodium alpha olefin sulfonate), sarcosinates (such as ammonium cyclohexyl palmitoyl taurinate), succinates (such as disodium N-octadecyl sulfosuccinamate), phosphorus derivatives (such as phosphoric acid esters and their equivalent salts); cationic surfactants including alkylbenzyltrimethylammonium chloride; and amphoteric surfactants including betaine. Particularly preferred foaming agents are Bio-Soft D-40, Bioterge AS-40, Ammonyx DO, Ammonyx LO, Steol CA-330, Cedepal TD-407, and Polystep B-25. The total concentration of foaming agents in the formulation will be dependent on the foaming agents used, and may comprise between about 0.1% and about 50% of the final formulation, preferably between about 0.3% and about 30%, more preferably between about 5% and 25%, and even more preferably between about 17% and about 23%.

In some embodiments, the composition is formulated as a suspension. A suspension concentrate may contain, for example, about 50, 80, 10, 150, 200, 250, 300, 350, and 400 grams of the active ingredient per liter. The concentrate can be diluted with a solvent, for example water, before being applied to a plant or soil. In some embodiments, the formulated composition is homogenous.

In another embodiment, the plant protection agent is a pyrethroid selected from bifenthrin, cypermethrin, beta-cypermethrin, zeta-cypermethrin, deltamethrin, cis-permethrin, gamma-cyhalothrin, tralomethrin, cyfluthrin, beta-cyfluthrin, esfenvalerate and fluvalinate. An aspect of the invention provides an agricultural composition of tetraniliprole for controlling fecundity of an Arachnida species.

Preferred insecticides to be combined with tetraniliprole are selected from the group consisting of abamectin, aldicarb, bendiacarb, carbaryl, carbofuran, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron, buprofezin, cyromazine, methoxyfenozide, chromafenozide, amitraz, indoxacarb, azadirachtin and pyridaben. Preferred fungicides are selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, pefurazoate, imazalil, triflumizole, cyazofamid, benomyl, carbendazim, thiabendazole, fuberidazole, ethaboxam, etridiazole and hymexazole, azaconazole, diniconazole-M, oxpoconazol, paclobutrazol, uniconazol, imazalilsulfphate, azoxystrobin, dimoxystrobin, fluoxastrobin, kresoxim-methyl, orysastrobin, picoxystrobin, pyraclostrobin, trifloxystrobin, enestroburin, carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, dimethomorph, flumorph, fluopicolide (picobenzamid), zoxamide, carpropamid, diclocymet, mandipropamid, bixafen, fluazinam, cyprodinil, fenarimol, ferimzone, mepanipyrim, nuarimol, pyrimethanil, fenpiclonil, fludioxonil, aldimorph, dodemorph, fenpropimorph, iprodione, procymidone, vinclozolin, famoxadone, fenamidone, probenazole, acibenzolar-S-methyl, captafol, captan, dazomet, folpet, fenoxanil, quinoxyfen, nitrapyrin, fluoroimid, blasticidin-S, chinomethionat, difenzoquat-methylsulphate, oxolinic acid, mancozeb, maneb, methasulphocarb, metiram, ferbam, propineb, thiram, zineb, ziram, diethofencarb, iprovalicarb, benthiavalicarb, propamocarb hydrochloride, guanidine, dodine, kasugamycin, validamycin A, binapacryl, dinobuton, dithianon, isoprothiolane, fosetyl-aluminum, pyrazophos, tolclofos-methyl, dichlofluanid, flusulfamide, hexachlorobenzene, phthalide, pencycuron, quintozene, thiophanate-methyl, tolylfluanid, cyflufenamid, cymoxanil, ethirimol, furalaxyl, metrafenone, iminoctadine-triacetate, iminoctadine-tris(albesilate), kasugamycin hydrochlorid-hydrat, dichlorophen, pentachlorophenol and its salts, dicloran, nitrothal-isopropyl, tecnazen, biphenyl, bronopol, diphenylamine, mildiomycin, oxine-copper and prohexadione calcium.

Among other preferred embodiments, the plant protection agent may be a pyrethroid compound. Non-limiting exemplary pyrethoids include acrinathrin, allethrin, bifenthrin, bioallethrin, bioresmethrin, cyclo professional Trindade (cycloprothrin), cyfluthrin, beta-cyfluthrin, cyhalothrin, cancer better halo Trindade (gamma-cyhalothrin), lambda cyhalothrin (lambda-cyhalothrin), cypermethrin, alpha-cypermethrin, beta-cypermethrin, theta cypermethrin, zeta cypermethrin (zeta-cypermethrin), cyphenothrin, deltamethrin, empenthrin, esfenvalerate, ethofenprox, Fenpropathrin, fenvalerate, flucythrinate, flumethrin, fluvalinate, tau full burr sulfonate, halfenprox, hepta full Trindade (heptafluthrin), imiprothrin, Kadesurin, Meperufurutorin (meperfluthrin), Mon-fluoro Trindade (momfluorothrin), permethrin, phenothrin, prallethrin, pyrethrins, resmethrin, silafluofen, tefluthrin, tetramethrin, tetramethyl full Trindade, tralomethrin and Transfluthrin. In more preferred embodiments, the plant protection agent is a pyrethroid selected from bifenthrin and zeta cypermethrin.

The plant protection agent is preferably present in a concentration of from about 1% by weight to about 55% by weight, more particularly, from about 15% by weight to about 35% by weight based upon the total weight of all components in the composition. Other exemplary ranges include from about 10% to about 35%, from about 10% to about 30%, from about 10% to about 20% by weight.

The ratio between tetraniliprole and the plant protection agent in weight may range from about 1:100 to about 100:1, all subranges included. In some embodiments, the ratio between tetraniliprole and the plant protection agent is in the ranges of about 1:30 to 30:1. In some embodiments, the ratio between tetraniliprole and the plant protection agent is in the ranges of about 1:15 to about 15:1. Non-limiting examples of the ratio between tetraniliprole and the plant protection agent is about 1:20, about 1:19, about 1:18, about 1:17, about 1:16, about 1:15, about 1:14, about 1:13, about 1:12, about 1:11, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19; and about 20:1.

In some exemplary embodiments, tetraniliprole is present accounts for about 1%, about 2%, about 3%, about 4%, about 5% of the composition by weight. In some embodiments, the plant protection agent accounts for less than about 1%, about 1%, about 2%, about 3%, about 4%, about 5% of the composition by weight.

Optionally, the composition further includes at least one additive. Examples include freeze agents, anti-foam agents and biocides. These formulation components are well-known in the agrochemical arts. In some embodiments, the anti-freeze agent is a polyalkylene glycol, preferably propylene glycol, and when present, is present in an amount from about 5% to about 9% by weight of the total of all components in the composition. In some embodiments, the anti-foam agent is an alkylcyclotetrasiloxane, preferably an octamethylcyclo-tetrasiloxane silicone emulsion, for example. DOW CORNING® AF Emulsion or DOWCORNING® ANTIFOAM C Emulsion (Dow Corning Corporation). If and when present in a non-foam formulation, the anti-foam agent is present in an amount of from about 0.001% to about 1% by weight of all the components in the total formulation. The preservative can be an isothiazolone or a mixture of isothiazolones, for example, KATHON® CG/ICP preservative or LEGEND® MK preservative (Rohm and Haas Corporation) or PROXEL™ BR preservative (Avecia Corporation). When present, the preservative is present in an amount of from about 0.001% to about 1% by weight of the total of all components in the formulation.

The compositions of the present invention may also contain a pH modifier. Exemplary pH ranges include about 4-8, 4-7, 5-6, and 6-7.

Formulations of compositions combined with fertilizers are desirable in agricultural and related endeavors due to the multiple benefits conveyed by just one application in a single piece of equipment. One application of such a combination or formulation provides nutrients for the plant growth, while eliminating or controlling unwanted insects that can also affect the health and vitality of the desirable plants. Accordingly, the composition of the present invention may also contain a liquid fertilizer. In some embodiments, the liquid fertilizer is aqueous-based. In some embodiments, the liquid fertilizer is present in a concentration of about 95.0% by weight to about 99.99% by weight based on the total weight of all components in the composition.

Tetraniliprole and its combination with one or more plant protection agents can be prepared in a suspension concentrate formulation. Various methods are known to prepare a SC formulation. An exemplary procedure is provided in U.S. Pat. No. 9,253,981, the entire disclosure of which is hereby incorporated by reference. The SC formulation may contain additional components such as a surfactant, an antifoam agent, a preservative, a thickener, water, and a suspending agent. Water is used as a diluent and preferably is purified water, for example, deionized or distilled water, and is present in an amount that would dilute the active ingredient to a desired concentration.

Another aspect of the invention provides a method for controlling fecundity of an Arachnida species using the compositions of the present invention. The method includes the step of applying to a plant or soil an effective amount of tetraniliprole and at least one plant protection agent. The composition may contain essentially just tetraniliprole as the active ingredient or may include additionally at least one plant protection agent. The plant protection agent is as described above. In some embodiments, the composition contains tetraniliprole and bifenthrin. In some embodiments, the composition contains tetraniliprole and zeta-cypermthrin. The ratio between tetraniliprole and the plant protection agent may vary as described above.

In one embodiment, the targeted pests are any Arachnida species including for example, mites and tick to the area requiring such control. Non-limiting example of mite families include spider mites (family Tetranychidae), thread-footed mites (family Tarsonemidae), and the gall mites (family Eriophyidae). In some embodiments, the compositions are used for controlling fecundity of two-spotted spider mite (TSSM or TSM).

The method of the present invention can be used in pest-infested areas. However, it is also suitable for pest prevention purposes and requires such control. The pests to be controlled may inhabit in various places, including for example, rice paddies, fields, tea plantations, orchards, non-plant land, house, nursery tray or nursery box, nursery soil and nursery mat, and the like. Accordingly, the compositions can be applied in different means and forms depending on specific needs to pest control. For example, both direct spray and foliar application can effectively control the egg production on the plant. Certainly, the method of the present invention is by no means limited to plant foliage application; other processes such as soil treatment and seed disinfection are also contemplated within the scope of the present invention.

Prior to application, the concentrations of the compositions may be readjusted. For example, tetraniliprole and/or the plant protection agent may account for about 0.0005 to 40% by weight in the composition. Other exemplary ranges include about 0.05 to about 10%, about 0.1 to about 10%, about 0.5 to about 10%, about 1 to about 10%, and about 1 to about 5%.

Tetraniliprole and/or the plant protection agent may be applied in a water volume at a rate of, for example, about 10, about 9, about 8, about 7, about 6, about 5, about 4, about 3, about 2 gallons or less per acre. In some embodiments, tetraniliprole and/or the plant protection agent are applied up to the maximum label rate for each ingredient.

In another embodiment, tetraniliprole and/or a secondary plant protection agent may be applied each at a rate ranging from about 0.05 lb ai/acre to about 10 lb ai/acre, all sub-ranges and sub-values included. In exemplary embodiments, tetraniliprole and/or a secondary agent may be applied independently at a rate of about 0.05, about 0.1, about 0.15, about 0.2, about 0.25, about 0.3, about 0.35, about 0.4, about 0.45, about 0.5, about 0.6, about 0.7, about 0.8, about 0.9, about 1.0, about 1.2, about 1.4, about 1.6, about 1.8, about 2.0, about 2.5, about 3, about 3.5, about 4, about 4.5, about 5, about 6, about 7, about 8, about 9, or about 10 lb/acre.

As described above, tetraniliprole and the plant protection agent may be mixed together and applied in the same formulation. Alternatively, tetraniliprole and the plant protection agent can be applied sequentially. The length of interval in-between the applications depend on factors such as the target pest and concentration of the ingredients and can be determined by one of ordinary skill in the art without undue experimentation.

The plants that are protected include, for example, agricultural crops, fruit trees and trees other than fruit trees, floricultural plants, and ornamentals. Examples of agricultural crops include corn, rice, wheat, barley, rye, oats, sorghum, cotton, soybean, pin-nuts, buckwheat, sugar beet, rapeseed, sunflower, sugar cane, tobacco, etc., vegetables; Solanaceae vegetables (eggplant, tomato, pin-Man, peppers, potatoes, etc.), Cucurbitaceae vegetables (cucumber, pumpkin, Zucchi—two, watermelon, melon, etc.), cruciferous vegetables (radish, turnip, horseradish, co-Rurabi, Chinese cabbage, cabbage, mustard, broccoli, cauliflower, etc.), Asteraceae vegetables (burdock, garland chrysanthemum, A-Ticho-clause, lettuce, etc.), Liliaceae vegetables (leek, onion, garlic, asparagus), Umbelliferae vegetables (carrot, parsley, celery, parsnip, etc.), Chenopodiaceae vegetables (spinach, Swiss chard, etc.), Labiatae vegetables (perilla, mint, basil, etc.), strawberry, sweet potato, yam, taro, etc., flowers, and foliage plants. Examples of fruit trees include pome fleshy fruits (apple, pear, Japanese pear, quince, quince, etc.), stone fruit (peach, plum, nectarine, plum, cherry, apricot, pull-down, etc.), citrus (satsuma mandarin, orange, lemon, lime, gray-Pufuru-Tsu, etc.), Kenhate-rui (chestnut, walnut, hazel. A-Monde, pistachio, cashew-nuts, macadamia nuts, etc.), berries, grape, persimmon, Cage-parts, loquat, banana, co-Non-, date palm, and coconut. Examples of trees other than fruit trees; tea, mulberry, flowers and trees, street trees (ash, birch, dogwood, Yu-Cali, ginkgo, lilac, maple, oak, poplar, Cercis chinensis, SEAL, sycamore, zelkova Kurobe, fir, hemlock, juniper, pine, spruce, yew), and the like. Examples of floricultural and ornamental plants; ageratum, azalea, begonia, chrysanthemum, dahlia, daisy, fuchsia, gerbera, gloxinia, ivy, jasmine, impatiens, lantana, larkspur, marigold, peperomia, petunia, snapdragon, verbena, violet, zinnia, and the like.

The hydrated aluminum-magnesium silicate is preferably selected from montmorillonite and attapulgite. The phosphate ester dispersant is preferably selected from a nonyl phenol phosphate ester and a tridecyl alcohol ethoxylated phosphate potassium salt.

The dispersant or dispersants are preferably present in a total concentration of from about 0.02% by weight to about 20% by weight based upon the total weight of all components in the composition.

The present invention further encompasses a process for preparing a composition according to the present disclosure by mixing tetraniliprole with at least one plant protection agent. The crop plant protection agent is as described above. One or more additives may also be included in the composition.

The compositions of the present invention are further illustrated by the examples below. These examples serve only to illustrate the invention and should not be interpreted as limiting the scope of the invention in any way, since further modifications encompassed by the disclosed invention will be apparent to those skilled in the art. All such modifications are deemed to be within the scope of the invention as defined in the present specification and claims.

### EXAMPLES

### Example 1

This example aims to assess mortality rates to TSSM when experimental samples are applied using the dip methodology to post-infested leaf disks. Efficacy of Test Formula (tetraniliprole 200 SC formulation) was examined as a solo and in combination with bifenthrin to control TSSM.

Adult female spider mites were transferred onto treated leaf (Pinto bean-Topaz variety) disks after the material had dried. Dead mites and number of eggs were counted at 4 h, 24 h, and 96 h after being infested.

No antagonistic effects were detected with a tank-mix of Test Formula and bifenthrin against adult TSSM. As shown in Table 1, the combination provided 100% control with no eggs deposited after 96 h. Solo, Test Formula (60 g ai/ha) and Brigade® (bifenthrin, 56 g ai/ha) provided 10% and 100% mortality, respectively. Coragen®@ (chlorantraniliprole) produced a significant flare in eggs compared to the untreated check.

It is also of note that Coragen had a statistically higher number of eggs per leaf disk at 96 h compared to the positive and negative controls; this potential flaring phenomenon will be further evaluated. Test Formula had a numerical reduction in the number of eggs deposited on leaf disks at 96 h compared to the untreated check.

TABLE 1
Treatment effects to spider mite mortality and fecundity after 10 mites
were on a leaf disk for 96 h (reps = 4).

| | | | Avg. No of |
|---|---|---|---|
| | Rates Tested | % | Eggs per |
| Treatments | (g ai/ha) | Mortality | Leaf Disk |
| Brigade | 56 g | 100 a | 0 c |
| Brigade | 112 g | 100 a | 0 c |
| Coragen | 60 g | 15 b | 134 a |
| Test Formula | 60 g | 10 b | 64 b |
| Test Formula + Brigade | 60 g + 56 g | 100 a | 0 c |
| Test Formula + Brigade | 60 g + 112 g | 100 a | 0 c |
| UTC | | 5b | 84b |

Note:
Values in each column that have the same letter are not statistically different when analyzed at a 90% CI, ANOVA, GLM.

### Example 2

This example serves to determine if Coragen causes flaring of egg production compared to Test Formula when TSSM are post-infested on a treated leaf disk.

Adult female spider mites were transferred onto treated leaf (Pinto bean-Topaz variety) disks after the material had dried. Dead mites and number of eggs were counted at 24, 48, and 120 h after being infested.

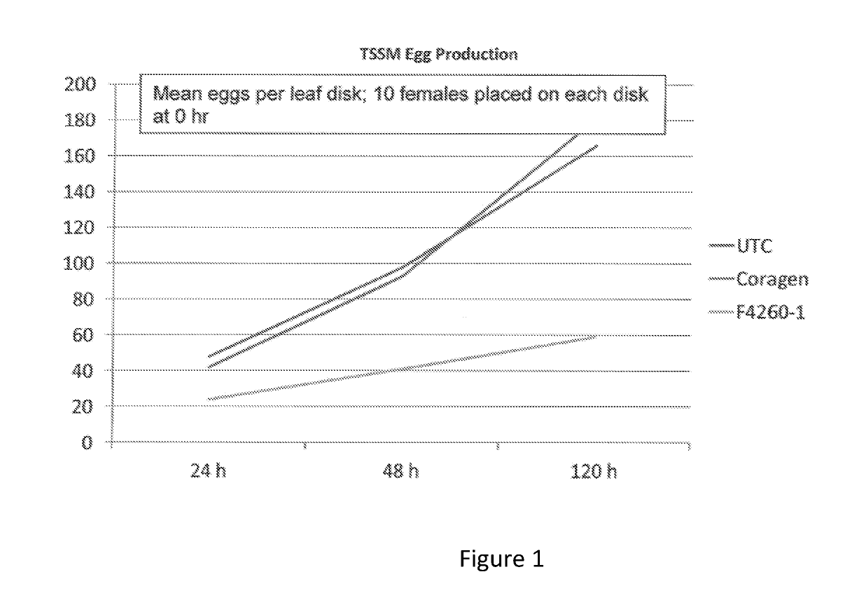

As shown in Tables 2-5 and FIG. 1, neither Test Formula nor Coragen at 213.8 ppm provided control to TSSM. Brigade® 2EC provided 85-100% control at 120 hrs. Brigade tank mixed with Test Formula showed no antagonistic effects to mite survival or egg deposition. A flaring phenomenon with Coragen was observed. Against TSSM, Test Formula showed statistically lower egg production (2.5× increase between 24-120 h) vs. UTC (3.5× increase). Coragen showed a higher egg production than the UTC (4.3× increase) at the same time interval (NS). Test Formula did not adversely affect egg hatch.

TABLE 2

| Treatments | % a.i. | Rates Tested (ppm) |
|---|---|---|
| Brigade | 25.1% | 1 |
| Brigade | 25.1% | 10 |
| Brigade | 25.1% | 30 |
| Brigade | 25.1% | 199.6 |
| Coragen | 18.4% | 213.8 |
| Test Formula | 18.2% | 213.8 |
| Test Formula + Brigade | | 213.8 + 1 |
| UTC | — | — |

TABLE 3
Treatment effects to spider mite mortality and fecundity
After 10 mites were on a leaf disk for 24 h (reps = 4)

| | Rates Tested | | Avg # of eggs |
|---|---|---|---|
| Treatment | (ppm) | % Mortality | Per leaf disk |
| Brigade 2EC | 1 | 10ab | 2.0c |
| Brigade 2EC | 10 | 2.5ab | 0.5c |
| Brigade 2EC | 30 | 5ab | 0c |
| Brigade 2EC | 199.6 | 17.5a | 0c |
| Coragen | 213.8 | 0b | 41.5a |
| Test Formula | 213.8 | 0b | 23.8b |
| Test Formula + Brig. | 213.8 + 1 | 5ab | 0c |
| UTC | — | 2.5ab | 48.2a |

Note:
Values in each column that have the same letter are not statistically different when analyzed at a 90% CI, ANOVA, GLM.

TABLE 4
48 hour evaluation results

| | Rates Tested | | Avg # of eggs |
|---|---|---|---|
| Treatment | (ppm) | % Mortality | Per leaf disk |
| Brigade 2EC | 1 | 22.5ab | 2.0c |
| Brigade 2EC | 10 | 12.5ab | 1.5c |
| Brigade 2EC | 30 | 15.0ab | 0.2c |
| Brigade 2EC | 199.6 | 27.5a | 0c |
| Coragen | 213.8 | 2.5b | 93.3a |
| Test Formula | 213.8 | 5.0ab | 40.8b |
| Test | 213.8 + 1 | 17.5ab | 0c |
| Formula + Brig. | | | |
| UTC | — | 0b | 97.8a |

TABLE 5
120 hour evaluation results

| | Rates Tested | | Avg # of eggs |
|---|---|---|---|
| Treatment | (ppm) | % Mortality | Per leaf disk |
| Brigade 2EC | 1 | 95a | 2.3c |
| Brigade 2EC | 10 | 85a | 1.0c |
| Brigade 2EC | 30 | 100a | 0.5c |
| Brigade 2EC | 199.6 | 100a | 0c |
| Coragen | 213.8 | 10b | 181.3a |
| Test Formula | 213.8 | 25b | 59b |
| Test | 213.8 + 1 | 90a | 0.3c |
| Formula + Brig. | | | |
| UTC | — | 27.5b | 165.7a |

### Example 3

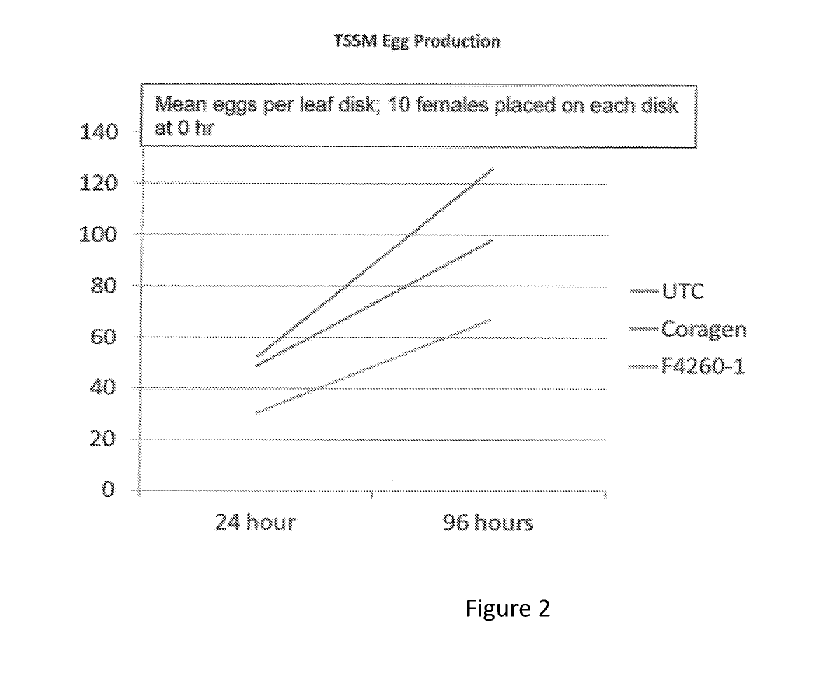

This example further studies the effect of Coragen and Test Formula on egg production when TSSM are post-infested on a treated leaf disk. Adult female spider mites were transferred onto treated leaf (Pinto bean-Topaz variety) disks after the material had dried. Living mites and number of viable eggs were counted at 24 and 96 hr after being infested. As shown in FIG. 2 and Tables 6-8. Test Formula statistically reduced the number of eggs deposited vs, the UTC and Coragen treatments, at 24 and 96HAT. Mortality and egg deposition data were collected for all 4 replicates and analyzed via ANOVA: GLM (α=0.1). Coragen had numerically lower egg production than the UTC. Rates chosen for bifenthrin in this assay were too low and there was no statistical difference from the UTC.

TABLE 6

| Treatments | % a.i. | Rates Tested (ppm) |
|---|---|---|
| Brigade | 25.1% | 0.03 |
| Brigade | 25.1% | 0.1 |
| Brigade | 25.1% | 0.3 |
| Coragen | 18.4% | 213.8 |
| Test Formula | 18.2% | 213.8 |
| Test Formula + Brigade | | 213.8 + 0.03 |
| UTC | — | — |

TABLE 7
Treatment effects to spider mite mortality and fecundity
After 10 mites were on a leaf disk for 24 h (reps = 4)

| | Rates Tested | | Avg # of eggs |
|---|---|---|---|
| Treatment | (ppm) | % Mortality | Per leaf disk |
| Brigade 2EC | 0.03 | 5 | 57.8 |
| Brigade 2EC | 0.1 | 2.5 | 44.3ab |
| Brigade 2EC | 0.3 | 0 | 43.8ab |
| Coragen | 213.8 | 0 | 48.8a |
| Test Formula | 213.8 | 5 | 30.5bc |
| Test | 213.8 + 0.03 | 10 | 22.5c |
| Formula + Brig. | | | |
| UTC | — | 0 | 52.5a |

Note:
Values in each column that have the same letter are not statistically different when analyzed at a 90% CI, ANOVA, GLM.

TABLE 8
Treatment effects to spider mite mortality and fecundity
After 10 mites were on a leaf disk for 24 h (reps = 4)

| | Rates Tested | | Avg # of eggs |
|---|---|---|---|
| Treatment | (ppm) | % Mortality | Per leaf disk |
| Brigade 2EC | 0.03 | 65 | 113ab |
| Brigade 2EC | 0.1 | 12.5 | 94abc |
| Brigade 2EC | 0.3 | 22.5 | 126.3a |
| Coragen | 213.8 | 5 | 98abc |
| Test Formula | 213.8 | 7.5 | 67c |
| Test Formula + Brig. | 213.8 + 0.03 | 22.5 | 78.5bc |
| UTC | — | 5 | 125.8a |

While this invention has been described with an emphasis upon preferred embodiments, it will be obvious to those of ordinary skill in the art that variations in the preferred compositions and methods can be used and that it is intended that the invention can be practiced otherwise than as specifically described herein. Accordingly, this invention includes all modifications encompassed within the spirit and scope of the invention as defined by the claims that follow.

What is claimed is:

1. A composition for controlling fecundity of an Arachnida species, comprising: an effective amount of tetraniliprole and at least one plant protection agent; wherein said plant protection agent is selected from the group consisting of pesticide, arthropodicide, insecticide, acaricide, nematocide, fungicide, herbicide, plant growth regulator and a combination thereof.

2. The composition of claim 1, wherein said plant protection agent is a pyrethroid selected from bifenthrin, cypermethrin, beta-cypermethrin, zeta-cypermethrin, deltamethrin, cis-permethrin, gamma-cyhalothrin, tralomethrin, cyfluthrin, beta-cyfluthrin, esfenvalerate and fluvalinate.

3. The composition of claim 1, wherein said plant protection agent is bifenthrin.

4. The composition of claim 1, wherein said plant protection agent is zeta-cypermethrin.

5. The composition of claim 1, wherein said tetraniliprole is present in at least 5% by weight.

6. The composition of claim 1, wherein said plant protection agent is present in at least 1% by weight.

7. The composition of claim 1, wherein the molar ratio between the tetraniliprole and the plant protection agent ranges from 1:100 to 100:1.

8. The composition of claim 1, further comprising a pH buffering agent, said buffering agent capable of maintaining the pH of the composition between about 5.5 to 6.5.

9. The composition of claim 1 further comprising a liquid fertilizer.

10. The composition of claim 8, wherein said liquid fertilizer is aqueous-based.

11. The composition of claim 9, wherein said liquid fertilizer is present in a concentration of about 95.0% by weight to about 99.99% by weight based on the total weight of all components in the composition.

12. The composition of claim 9, further comprising at least one additive selected from the group consisting of anti-freeze agents, anti-foam agents, biocides.

13. The composition of claim 9, which is homogenous.

14. A method of controlling fecundity of an Arachnida species, comprising applying to a plant or soil:
a composition comprising an effective amount of tetraniliprole and at least one plant protection agent,
wherein said plant protection agent is selected from the group consisting of pesticide, arthropodicide, insecticide, acaricide, nematocide, fungicide, herbicide, plant growth regulator and a combination thereof.

15. The composition of claim 14, wherein said plant protection agent is a pyrethroid selected from bifenthrin, cypermethrin, beta-cypermethrin, zeta-cypermethrin, deltamethrin, cis-permethrin, gamma-cyhalothrin, tralomethrin, cyfluthrin, beta-cyfluthrin, esfenvalerate and fluvalinate.

16. The composition of claim 14, wherein said plant protection agent is bifenthrin.

17. The composition of claim 14, wherein said plant protection agent is zeta-cypermethrin.

18. The method of claim 14, wherein said composition is applied at a rate of about 2 to about 7 gallons per acre.

19. The method of claim 14, wherein said tetraniliprole and said plant protection agent are applied separately.

20. The method of claim 14, wherein said tetraniliprole and said plant protection agent are provided in the same formulation.

21. The method of claim 14, wherein the Arachnida species is a mite.

22. The method of claim 14, wherein the Arachnida species is a two-spotted spider mite (TSSM).

23. The method of claim 14, which inhibit at least one of the Arachnida life stage selected from egg, larva, nymph, and adult.

24. The method of claim 13 or claim 15, which inhibit the growth of adult insects.

25. A method of controlling fecundity of an Arachnida species, comprising applying a composition comprising an effective amount of tetraniliprole to the area requiring such control.

26. The method of claim 24, wherein said composition is applied at a rate of about 2 to about 7 gallons per acre.

27. The method of claim 24, wherein the Arachnida species is a two-spotted spider mite (TSSM).
